(19) United States
(12) Patent Application Publication
(10) Pub. No.: US 2024/0429571 A1
(43) Pub. Date: Dec. 26, 2024

(54) SECONDARY BATTERY

(71) Applicant: KABUSHIKI KAISHA TOSHIBA, Tokyo (JP)

(72) Inventors: Yoshiaki ARAKI, Yokohama (JP); Takuma YANO, Tokyo (JP)

(73) Assignee: KABUSHIKI KAISHA TOSHIBA, Tokyo (JP)

(21) Appl. No.: 18/822,991

(22) Filed: Sep. 3, 2024

Related U.S. Application Data
(63) Continuation of application No. PCT/JP2022/034978, filed on Sep. 20, 2022.

(51) Int. Cl. H01M 50/536; H01M 50/103; H01M 50/15; H01M 50/538

(52) U.S. Cl. CPC H01M 50/536; H01M 50/103; H01M 50/15; H01M 50/538

(57) ABSTRACT

According to one embodiment, a secondary battery includes an outer container, an electrode terminal attached to the outer container and including a first junction surface exposed to an outside of the outer container and a second junction surface exposed to an inside of the outer container and opposing the first junction surface, and an electrode body housed in the outer container, including an electrode group and a current collecting tab group containing a plurality of current collecting tabs extending from the electrode group and directly joined to the second junction surface of the electrode terminal.

### CROSS-REFERENCE TO RELATED APPLICATIONS

This application is a Continuation Application of PCT Application No. PCT/JP2022/034978, filed Sep. 20, 2022, the entire contents of which are incorporated herein by reference.

### FIELD

Embodiments described herein relate generally to a secondary battery and a method of manufacturing the same.

### BACKGROUND

In recent years, secondary batteries with high energy density, for example, lithium-ion secondary batteries, have been widely used as power sources for electronic devices and electric vehicles. Such secondary batteries are configured by housing an electrode body having a positive electrode and a negative electrode and a nonaqueous electrolyte in a rectangular-shaped outer container made of aluminum or aluminum alloy. The lid of the outer container is provided with a positive output terminal, a negative output terminal and the like. The positive and negative output terminals are connected to the respective positive electrode and negative electrode current collecting tabs of the electrode body via positive and negative electrode leads provided in the outer container, respectively.

In such secondary batteries as described above, it is necessary to provide space for current collecting tabs and leads between the output terminal and the electrode body, and therefore it is difficult to increase the volumetric energy density of the secondary battery. Further, the work of joining the current collecting tabs to the leads and the work of joining the leads to the output terminal are necessary, which complicates the manufacturing process and increases the manufacturing cost.

### BRIEF DESCRIPTION OF THE DRAWINGS

FIG. 1 is a perspective view showing the appearance of a secondary battery according to the first embodiment.

FIG. 2 is an exploded perspective view of the secondary battery.

FIG. 3 is a perspective view showing an example of an electrode body.

FIG. 4 is a cross-sectional view of the secondary battery taken along line B-B in FIG. 1.

FIG. 5 is a plan view showing a rear surface side of a lid of the secondary battery.

FIG. 6 is a cross-sectional view of the secondary battery taken along line A-A in FIG. 1.

FIG. 7 is an assembly diagram of the secondary battery, schematically showing an ultrasonic junction process between an electrode terminal and a current collecting tab group of the secondary battery.

FIG. 8 is a perspective view showing an end portion of a lid side of a secondary battery according to the second embodiment.

FIG. 9 is a cross-sectional view of the lid portion of the secondary battery taken along line C-C in FIG. 8.

FIG. 10 is a perspective view showing an end portion of a lid side of a secondary battery according to the third embodiment.

FIG. 11 is a cross-sectional view of the lid portion of the secondary battery taken along line D-D in FIG. 10.

FIG. 12 is a perspective view showing an end portion of a lid side of a secondary battery according to the fourth embodiment.

FIG. 13 is a cross-sectional view of the lid portion of the secondary battery taken along line D-D in FIG. 12.

### DETAILED DESCRIPTION

In general, according to one embodiment, a secondary battery comprises an outer container, an electrode terminal attached to the outer container and including a first junction surface exposed to an outside of the outer container and a second junction surface exposed to an inside of the outer container and opposing the first junction surface, and an electrode body housed in the outer container, including an electrode group and a current collecting tab group containing a plurality of current collecting tabs extending from the electrode group and directly joined to the second junction surface of the electrode terminal.

Embodiments will be described hereinafter with reference to the accompanying drawings. Note that the disclosure is merely an example, and proper changes within the spirit of the invention, which are easily conceivable by a skilled person, are included in the scope of the invention as a matter of course. In addition, in some cases, in order to make the description clearer, the widths, thicknesses, shapes, etc., of the respective parts are schematically illustrated in the drawings, compared to the actual modes. Further, in the specification and drawings, corresponding elements are denoted by like reference numerals, and a detailed description thereof may be omitted unless otherwise necessary.

### First Embodiment

A secondary battery according to a first embodiment is described in detail as a secondary battery.

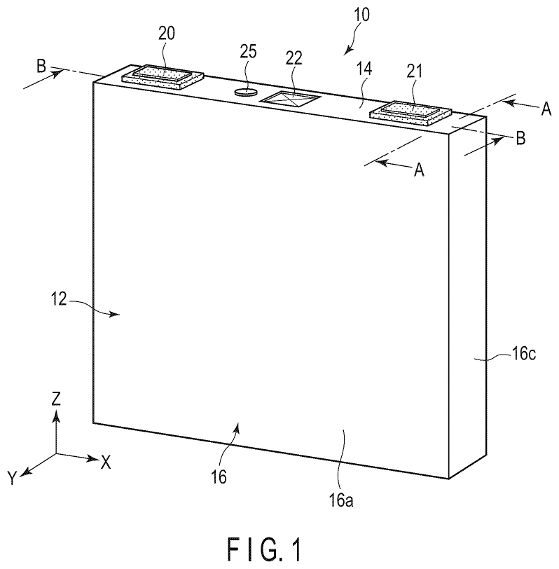

FIG. 1 is a diagram showing the appearance of the secondary battery according to the first embodiment.

As shown in the drawing, a secondary battery 10 is a nonaqueous electrolyte secondary battery, such as a lithium ion battery, and comprises an outer container 12 of a flat, approximately rectangular shape, and an electrode body 30 described below, which is stored in the outer container 12 with the nonaqueous electrolyte. The outer container 12 is, for example, an outer can (battery case) made of a metal plate such as aluminum, aluminum alloy, iron, or stainless steel.

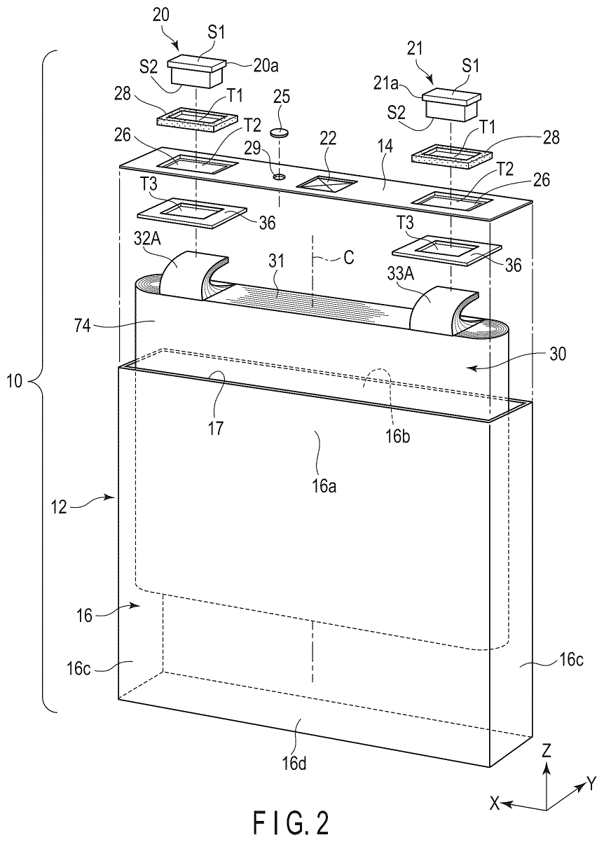

The outer container 12 includes a container body 16 with an open top end and a rectangular plate-shaped lid 14 welded to the container body 16 and closing the top opening of the container body 16, forming an airtight interior. The lid 14 is provided with a positive electrode terminal 20 and a negative electrode terminal 21 as a pair of output terminals, a pressure relief valve (safety valve) 22, and an inlet port 29 (see FIG. 2). The inlet port 29 is sealed by a disk-shaped sealing lid 25.

Here, a longitudinal direction of the lid 14 and the container body 16 is defined as X, a width direction of the lid 14 and the container body 16 orthogonal to the longitudinal direction X as Y, and a height direction of the container body 16 as Z.

FIG. 2 is an exploded perspective view of the secondary battery.

As shown in FIG. 2, the container body 16 of the outer container 12 has a rectangular long side wall 16a, a rectangular long side wall 16b that faces the long side wall 16a in parallel at a distance from the long side wall 16a, a pair of short side walls 16c facing each other, and a bottom wall 16d. A rectangular upper (top) opening 17 is defined by upper edges of the pair of long side walls 16a and 16b and upper edges of the pair of short side walls 16c.

The lid 14 is formed as a rectangular plate substantially equal in size to the upper opening 17. The lid 14 is fixed to the container body 16 with its outer circumferential edge welded to an upper edge circumferential portion of the container body 16, closing the upper opening 17.

Rectangular recesses 26 are formed at respective end portions of the lid 14 in the longitudinal direction X, and a sealing material, for example, a gasket 28, made of synthetic resin, glass, or other insulating material is attached to each of these recesses 26. Rectangular through holes T1 and T2 are formed in the center portion of the respective recesses 26 and gaskets 28. Two rectangular plate-shaped insulators 36 are provided on the inner surface side of the lid 14. The insulators 36 are disposed at positions opposing the recesses 26, respectively. Each insulator 36 has a rectangular through hole T3. The positive electrode terminal 20 is formed

of a conductive metal into an approximately rectangular shape and includes a flange 20a integrated thereto around an outer circumference of one end thereof. An end surface (upper surface) on a flange 20a side of the positive electrode terminal 20 constitutes a first junction surface S1 that is exposed to the outside of the secondary battery 10. Another end surface (lower surface) on the other end of the positive electrode terminal 20 constitutes a second junction surface S2 exposed to the inside of the outer container 12. The first junction surface S1 and the second junction surface S2 oppose each other in approximately parallel to each other. The positive electrode terminal 20 is attached to the lid 14 via a gasket 28. The end portion of the positive electrode terminal 20 on an opposite side to the flange 20a is inserted through the through holes T1, T2, and T3 of the gasket 28, the recess 26, and the insulator 36, so as to project into the container body 16.

The negative electrode terminal 21 is configured in a manner similar to that of the positive electrode terminal 20. That is, the negative electrode terminal 21 is formed of a conductive metal in an approximately rectangular shape and includes a flange 21a integrated thereto around the outer circumference of one end thereof. The end surface (upper surface) of the negative electrode terminal 21 on a flange 21a side constitutes the first junction surface S1 that is exposed to the outside of the secondary battery 10. The end surface (lower surface) on the other end of the negative electrode terminal 21 constitutes the second junction surface S2 exposed inside the outer container 12. The first junction surface S1 and the second junction surface S2 oppose each other in approximately parallel to each other. The negative electrode terminal 21 is attached to the lid 14 via a gasket 28. The end portion of the negative electrode terminal 21 on an opposite side to the flange 21a is inserted through the through holes T1, T2, and T3 of the gasket 28, recess 26, and insulator 36, and project into the container body 16.

Note that, for example, aluminum, aluminum alloy, copper or copper alloy can be used as the conductive metal that forms the positive and negative electrode terminals 20 and 21, respectively.

The lid 14 has a safety valve (pressure relief valve) 22, which functions as a gas venting mechanism, and a nonaqueous electrolyte inlet port 29 formed therein. The safety valve 22 is formed in the center of the lid 14 in the longitudinal direction X and is provided between the positive electrode terminal 20 and the negative electrode terminal 21. The safety valve 22 is formed by making a part of the area of the lid 14 approximately half the thickness of the other areas. When gas is generated in the outer container 12 due to an abnormal mode of the secondary battery 10, or the like, and the internal pressure of the outer container 12 rises to or above a predetermined value, the safety valve 22 is opened to reduce the internal pressure and prevent the outer container 12 from problems such as bursting.

The inlet port 29 is formed on the lid 14 between the positive electrode terminal 20 and the safety valve 22. After pouring the nonaqueous electrolyte into the outer container 12 through the inlet port 29, the inlet port 29 is sealed with the disk-shaped sealing lid 25, for example.

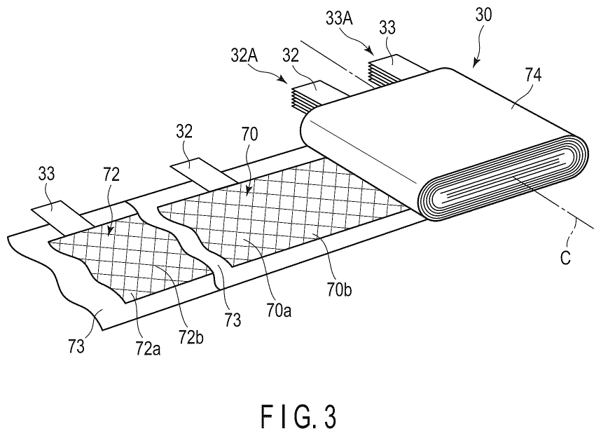

FIG. 3 is a perspective view showing an example of an electrode body.

In one example, a so-called wound electrode body is used as the electrode body 30 stored in the outer container 12. As shown in FIG. 3, the electrode body 30 includes an electrode group 74 formed by, for example, winding a sheet-shaped positive electrode plate 70 and a sheet-shaped negative electrode plate 72, respectively, spirally around a winding axis C with a sheet-shaped separator 73 interposed therebetween. The electrode group 74 is further compressed in a radial direction so that its cross-sectional shape becomes a rectangular shape substantially the same as the cross-sectional shape of the outer container 12, and thus formed into a flat rectangular shape. The separator 73 is placed on the outermost layer (outermost circumference) of the electrode group 74.

The electrode group 74 is held in a wound state by a winding tape or the like, which is not shown in the figure.

The positive electrode plate 70 has, for example, a strip-shaped positive electrode current collector 70a made of metal foil, a positive electrode active material layer 70b formed on at least one side of the positive electrode current collector 70a, and a plurality of positive electrode current collecting tabs 32, each of which is a strip-shaped, extending in a direction parallel to the wound axis C from multiple locations on a long side of the positive electrode collector 70a.

The negative electrode plate 72 has a strip-shaped negative electrode current collector 72a made of metal foil, a negative electrode active material layer 72b formed on at least one side of the negative electrode current collector 72a, and a plurality of negative electrode current collecting tabs 33, each of which is a strip-shaped, extending in a direction parallel to the winding axis C from multiple locations on a long side of the negative electrode collector 72a.

The positive electrode current collecting tabs 32 and the negative electrode current collecting tabs 33 may each be formed by punching out a current collector. That is, each of the current collectors and current collecting tabs is formed from, for example, a metal foil. The thickness of the metal foil, that is, the thickness per current collecting tab, should preferably be 5 μm or more and 50 μm or less. By setting the thickness to 5 μm or more, the breakage of the current collector and current collecting tabs, which may occur during manufacturing can be prevented, thereby making it possible to achieve high current collection efficiency. Further, it is also possible to avoid dissolution of the current collecting tabs when a large current is applied. On the other hand, by setting the thickness to 50 μm or less, the number of laps constituting the electrode body can be increased while reducing the increase in thickness of the electrode body. Preferably, the thickness of the metal foil should be 10 μm or more and 20 μm or less. For example, aluminum, aluminum alloy, copper or copper alloy can be used as the material of the metal foil, although the material can be changed depending on the type of active material used for the positive and negative electrodes.

By stacking and winding the positive electrode plate 70, separator 73, and negative electrode plate 72, a plurality of positive electrode current collecting tabs 32 are stacked to be aligned with each other in the thickness direction of the electrode group 74, thus forming a positive electrode current collecting tab group 32A. Similarly, a plurality of negative electrode current collecting tabs 33 are stacked to be aligned with each other in the thickness direction of the electrode group 74, thus forming a negative electrode current collecting tab group 33A. The positive electrode current collecting tab group 32A and the negative electrode current collecting tab group 33A extend in the same direction in the axial direction from one end of the electrode group 74 and are located to be apart from each other in the longitudinal direction of the electrode group 74 that is orthogonal to the axial direction.

As shown in FIG. 2, the electrode body 30 is stored within the container body 16 while the wound axis C thereof coincides with the height direction Z of the outer container 12 and one end surface 31 of the electrode group 74, the positive electrode collecting tab group 32A, and the negative electrode collecting tab group 33A are orientated to be located on a lid body 14 side. The one end surface 31 of the electrode group 74 opposes the lid 14 with a predetermined distance therebetween. The positive electrode current collecting tab group 32A is located on one end side of the electrode body 30 in the longitudinal direction X. The end portion of the extending side of the positive electrode current collecting tab group 32A is bent in the width direction Y and extends in a direction approximately parallel to the one end surface 31 of the electrode group 74 and opposes the positive electrode terminal 20. The negative electrode current collecting tab group 33A is located at the other end side of the electrode body 30 in the longitudinal direction X. The end portion of the extending side of the negative electrode current collecting tab group 33A is bent in the width direction Y and extends in a direction approximately parallel to the one end surface 31 of the electrode group 74 and opposes the negative electrode terminal 21.

Note that the extending end portion of the positive electrode current collecting tab group 32A may be held together by a holder cap bent into a U-shape (, which may as well be referred to as a backup lead). Similarly, the extending end portion of the negative electrode current collecting tab group 33A may be held together by a holder cap bent into U-shape.

The internal configuration of the secondary battery 10 thus assembled will now be described.

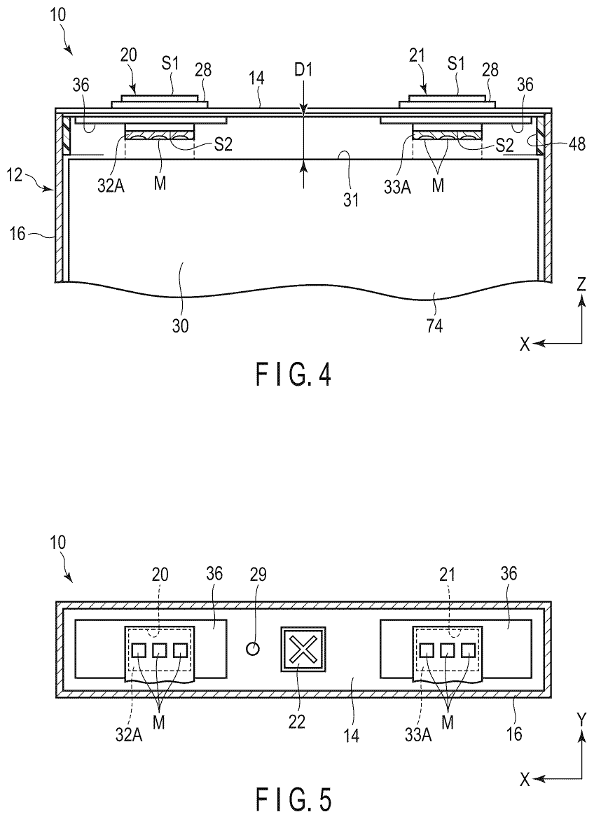

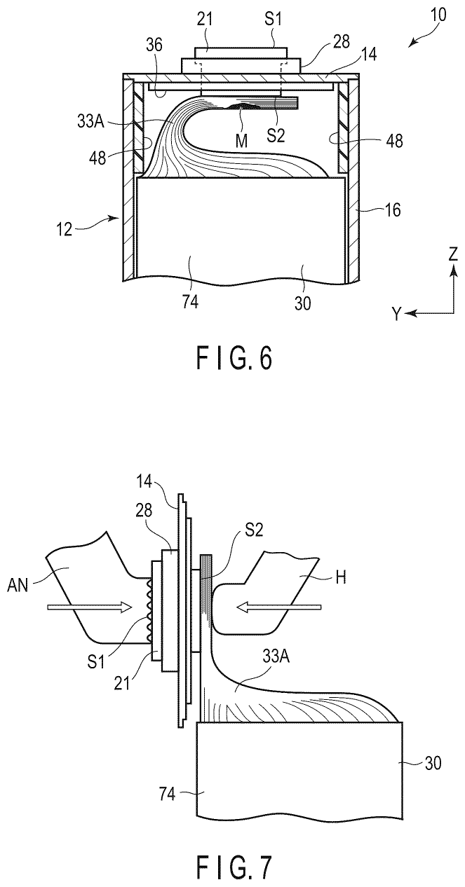

FIG. 4 is a cross-sectional view of the secondary battery taken along line B-B in FIG. 1, FIG. 5 is a plan view showing an inner surface side of the lid, and FIG. 6 is a cross-sectional view of the secondary battery taken along line A-A in FIG. 1.

As shown in FIG. 4, the lid 14 is fixed to the upper end edge of the container body 16 and hermetically closes the upper opening of the container body 16. The positive electrode terminal 20 is attached to the outer surface of the lid 14 via the gasket 28. The first junction surface S1 of the positive electrode terminal 20 is exposed to the outside of the secondary battery 10 and is disposed approximately parallel to the outer surface of the lid 14. The positive electrode terminal 20 extends into the container body 16 via a through hole T1 of the gasket 28, a through hole T2 of the lid 14, and a through hole T3 of the insulator 36. The second junction surface S2 of the positive electrode terminal 20 is exposed to the inside of the container body 16 and is disposed approximately parallel to the inner surface of the lid 14. Further, the second junction surface S2 opposes the end surface 31 of the electrode body 30 so as to be approximately parallel thereto with an interval therebetween. The lid 14 and the positive electrode terminal 20 are electrically insulated from each other by the gasket 28 and the insulator 36.

The extending end portion of the positive electrode current collecting tab group 32A opposes parallel to the second junction surface S2 of the positive electrode terminal 20 and is brought into direct contact with the second junction surface S2. Further, the extending end of the positive electrode current collecting tab group 32A is directly joined (welded) to the second junction surface S2 by ultrasonic junction as described below. As a result, the positive electrode terminal 20 is electrically connected to the positive electrode plate 70 of the electrode body 30 via the positive electrode current collecting tab group 32A.

When ultrasonic junction is used, as shown in FIG. 5, a horn mark (a horn pressure mark) M remains in a portion of the extending end portion of the positive electrode current collecting tab group 32A, which is located on an electrode body 30 side. In one example, a horn mark (pressure mark) M, which is constituted by three rectangular recesses aligned in the longitudinal direction X remains in the extending end portion of the positive electrode current collecting tab group 32A.

As shown in FIGS. 4 and 6, the negative electrode terminal 21 is attached to the outer surface of the lid 14 via the gasket 28. The first junction surface S1 of the negative electrode terminal 21 is exposed to the outside of the secondary battery 10 and is disposed approximately parallel to the outer surface of the lid 14. The negative electrode terminal 21 extends to the inside of the container body 16 via a through hole T1 of the gasket 28, a through hole T2 of the lid 14, and a through hole T3 of the insulator 36. The second junction surface S2 of the negative electrode terminal 21 is exposed to the inside of the container body 16 and is disposed approximately parallel to the inner surface of the lid 14. Further, the second junction surface S2 opposes the end surface 31 of the electrode body 30 approximately parallel thereto with an interval therebetween. The lid 14 and the negative electrode terminal 21 are electrically insulated from each other by the gasket 28 and the insulator 36.

The extending end portion of the negative electrode current collecting tab group 33A opposes parallel to the second junction surface S2 of the negative electrode terminal 21 and is brought into direct contact with the second junction surface S2. Further, the extending end portion of the negative electrode current collecting tab group 33A is directly joined (welded) to the second junction surface S2 by ultrasonic junction, which will be described later. With this configuration, the negative electrode terminal 21 is electrically connected to the negative electrode plate 72 of the electrode body 30 via the negative electrode current collecting tab group 33A.

When ultrasonic junction is used, as shown in FIG. 5, a horn trace (horn pressure trace) M remains on a part of the extending end portion of the negative electrode current collecting tab group 33A, which is located on the electrode body 30 side. In one example, a horn mark (pressure mark) M constituted by three rectangular recesses aligned in the longitudinal direction X remains in the extending end of the negative electrode current collecting tab group 33A.

In the outer container 12, a rectangular frame-shaped insulating member 48 is provided between the electrode body 30 and the lid body 14 so as to surround the positive electrode current collecting tab group 32A and the negative electrode current collecting tab group 33A. The insulating member 48 is formed from an insulating material such as synthetic resin in the form of a sheet or plate having a predetermined thickness. In one example, the insulating member 48 is attached onto the inner surface of the container body 16 so as to cover the region between the end of the container body 16 on an upper opening side and the end surface 31 of the electrode body 30 over the entire circumference. The positive electrode current collecting tab group 32A and the negative electrode current collecting tab group 33A are electrically insulated from the container body 16 by the insulating member 48.

For jointing of the aforementioned current collecting tab groups to the electrode terminals, laser welding, ultrasonic welding, resistance welding, and the like can be used. According to this embodiment, the current collecting tab groups are joined to the electrode terminals by ultrasonic junction.

FIG. 7 is a diagram schematically illustrating the joining process.

As shown in FIG. 7, in one example, with the extending end portion of the negative electrode tab group 33A of the negative electrode terminal 21 attached to the lid 14 in contact with the second junction surface S2, the dual head (horn H and anvil AN) of the ultrasonic joining device is disposed to interpose the negative electrode terminal 21 and the extending end portion of the negative electrode current collecting tab group 33A from both sides. The horn H is brought into contact with the outer surface side of the negative electrode current collecting tab group 33A (the outer surface on an opposite side to the negative electrode terminal 21) so as to press the negative electrode current collecting tab group 33A toward the second junction surface S2 of the negative electrode terminal 21 with a predetermined load. The other one, the anvil AN is brought into contact with the first junction surface S1 of the negative electrode terminal 21 so as to press the negative electrode terminal 21 toward the negative electrode current collecting tab group 33A with a predetermined load. In this state, the horn H and anvil AN are subjected to ultrasonic vibration in opposite phase. By applying the load and ultrasonic vibration to the junction interface, the oxide film and contamination on the junction interface are removed and the metal atoms are joined to each other by inter-electronic forces. That is, the junction interface is the second junction surface S2, and the extending end portion of the negative electrode current collecting tab group 33A is joined to the second junction surface S2 of the negative electrode terminal 21, and joined directly to the negative electrode terminal 21.

By an ultrasonic junction method similar to the above, the extending end portion of the positive electrode current collecting tab group 32A is joined to the second junction surface S2 of the positive electrode terminal 20 and joined directly to the positive electrode terminal 20. Ultrasonic junction of the positive electrode terminal 20 to the positive electrode current collecting tab group 32A may be performed simultaneously with junction of the negative electrode terminal 21 to the negative electrode current collecting tab group 33A, or in any order.

After the positive electrode current collecting tab group 32A and the negative electrode current collecting tab group 33A are ultrasonically joined to the positive electrode terminal 20 and the negative electrode terminal 21, respectively, the electrode body 30 is disposed inside the container body 16, and further the lid 14 is fixed to the upper end edge of the container body 16 by laser welding or the like. Thus, the secondary battery 10 is then assembled.

When the ultrasonic junction described above is used, as shown in FIGS. 4 to 6, a horn mark (horn pressure mark) M remains in the outer surface of the extending portion of each of the current collecting tab groups 32A and 33A. In one example, a horn mark (pressure mark) M constituted by three rectangular recesses aligned in the longitudinal direction X remain in the outer surface of each tab group. Further, as shown in FIG. 1, a plurality of dot-like pressing marks by the anvil AN remain in the first junction surface S1 of the positive terminal 20 and the first junction surface S1 of the negative terminal 21.

With the secondary battery 10 according to the first embodiment configured as described above, the leads conventionally used are omitted and each electrode terminal is directly jointed to the current collecting tab group of the electrode body 30. Thus, by omitting the leads, the number of parts can be reduced and manufacturing costs can be lowered. At the same time, the work of joining the current collecting tab group to the leads is unnecessary, and therefore the assembly work can be simplified and the manufacturing cost can be reduced.

Further, by omitting the leads, the installation space for the leads is unnecessary. Therefore, the space between the lid 14 and the end surface 31 of the electrode body 30 can be reduced and the volumetric energy density of the secondary battery can be increased. In one example, a distance D1 between the lid 14 and the electrode body 30 (see FIG. 4) can be ½ or less as compared to a secondary battery with leads. With this configuration, when the height of the outer container is the same as that of a conventional secondary battery, the height of the electrode body to be housed is increased and the battery capacity can be increased. Alternatively, when the battery capacity is the same as that of a conventional secondary battery, the height of the outer container can be lowered and thus the size of the secondary battery can be reduced.

As described above according to the first embodiment, it is possible to provide a secondary battery with increased volumetric energy density and reduced manufacturing cost.

Next, a secondary battery according to another embodiment of this invention will be described. In this embodiment to be described below, parts and constituent members identical to those of the first embodiment described above will be denoted with the same reference symbols as those used in the first embodiment, and the descriptions thereof will be omitted or simplified. The description will focus on the parts that differ from those of the first embodiment.

### Second Embodiment

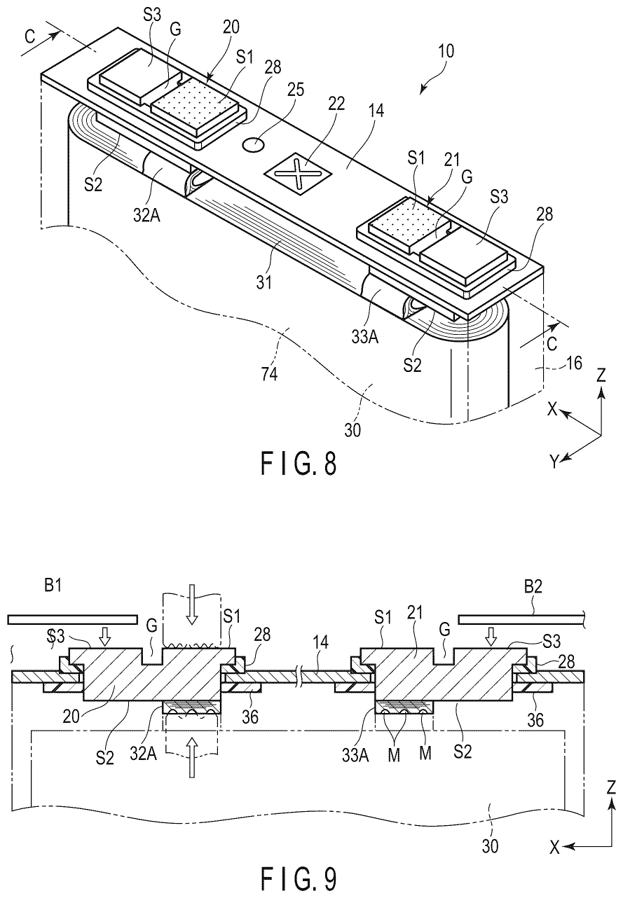

FIG. 8 is a perspective view of the secondary battery of the second embodiment, with omission of the container body, and FIG. 9 is a cross-sectional view of the lid and electrode terminals taken along line C-C in FIG. 8.

As shown in the figure, according to the secondary battery 10 of the second embodiment, each of the positive electrode terminal 20 and the negative electrode terminal 21 comprises a third junction surface S3 exposed to the outside in addition to the first junction surface S1 exposed to the outside and the second junction surface S2 exposed to the inside of the outer container 12.

The first junction surface S1 has, for example, a rectangular shape and extends approximately parallel to the upper surface of the lid 14. At the same time, the first junction surface S1 opposes approximately parallel to the second junction surface S2. The third junction surface S3 has, for example, a rectangular shape and extends approximately parallel to the upper surface of the lid 14. The third junction surface S3 is located to be aligned with the first junction surface S1 in the longitudinal direction X and opposes approximately parallel to the second junction surface S2. In the longitudinal direction X, the first junction surface S1 is located in a central side of the lid 14 and the third junction surface S3 is located at one end side of the lid 14.

The third junction surface S3 is formed at approximately the same height as that of the first junction surface S1 and is located in the same plane as the first junction surface S1. Between the first junction surface S1 and the third junction surface S3, a groove G is provided to extend in the width direction Y. The first junction surface S1 and the third junction surface S3 are spaced apart from each other in the longitudinal direction X while interposing the groove G therebetween. In this embodiment, the third junction surface S3 is formed to be slightly smaller in size than the first junction surface S1.

As shown in FIG. 9, the first junction surfaces S1 of the positive electrode terminal 20 and the negative electrode terminal 21 serve as contact surfaces with which the anvil AN is brought into contact during ultrasonic junction. That is, when the current collecting tab group is ultrasonically joined to the electrode terminal, the ultrasonic junction is carried out while the anvil AN of the ultrasonic junction device is being pressed against the first junction surface S1 and the horn H is being pressed against the current collecting tab group. Thus, the current collecting tab groups 32A and 33A of the positive and negative electrodes are joined to the region of the second junction surface S2, which opposes the first junction surface S1. After junction, a plurality of dotted pressure marks (recesses) remain on the first junction surface S1 and a plurality of pressure marks M remain on the positive and negative electrode current collecting tab groups 32A and 33A.

The third junction surfaces S3 of the positive electrode terminal 20 and the negative electrode terminal 21 serve as junction surfaces for joining bus bars (connecting members) B1 and B2. The bus bars B1 and B2 are joined to the third junction surfaces S3 of the positive electrode terminal 20 and the negative electrode terminal 21, respectively, by laser welding, for example.

As described above, according to the second embodiment, the junction surfaces of the electrode terminals which are exposed to the outside include the first junction surface S1 for ultrasonic junction and the third junction surface S3 for joining bus bars. With this configuration, it is possible to carry out both directly joining a current collecting tab group to the electrode terminal and joining a bus bar to the flat third junction surface S3 without pressure marks, for example, laser welding. By joining bus bars to the flat third junction surface S3 without pressure marks, the occurrence of junction error can be suppressed, thus making it possible to improve the reliability.

Note that in the second embodiment, the arrangement of the first junction surface S1 and the third junction surface S3 may be reversed from that of the embodiment described above. That is, the third junction surface S3 may be arranged on the central side of the lid 14 and the first junction surface S1 may be arranged on one end side of the lid 14. The arrangement of the junction surfaces can be selected according to the positional relationship with the electrode body 30.

### Third Embodiment

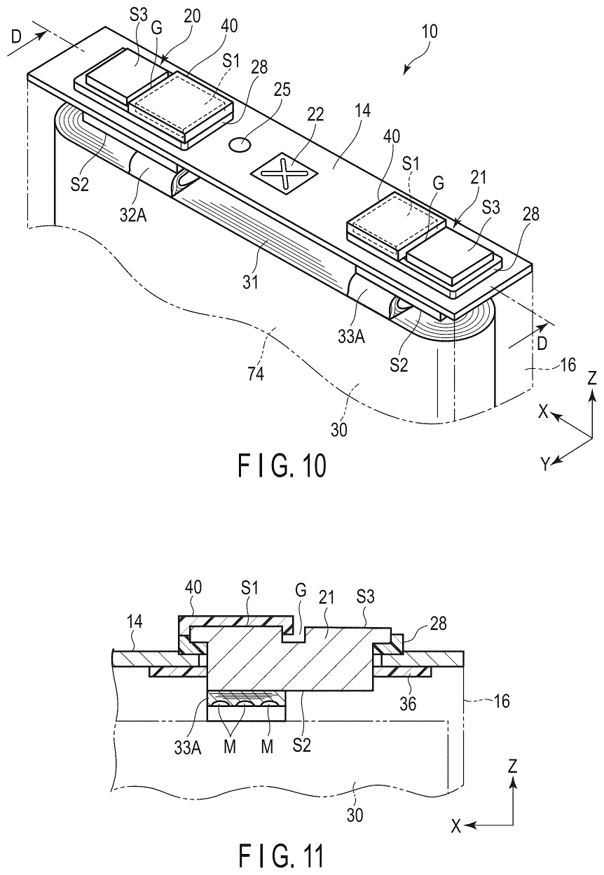

FIG. 10 is a perspective view showing a secondary battery of the third embodiment, with omission of the container body, and FIG. 11 is a cross-sectional view of the lid and electrode terminals, taken along line D-D in FIG. 10.

As shown in the figures, the secondary battery 10 according to the third embodiment comprises insulating covers 40 respectively attached to the positive and negative electrode terminals 20 and 21 illustrated in the second embodiment provided above. The insulation covers 40 are each formed of an insulating material into a shape of an approximately rectangular cap. The insulation covers 40 are respectively attached to the positive electrode terminal 20 and the negative electrode terminal 21 so as to cover the first junction surface S1 where pressure marks remain. In one example, after the current collecting tab groups are directly and ultrasonically joined to the positive electrode terminal 20 and the negative electrode terminal 21, respectively, the first junction surfaces S1, where pressure marks of the anvil remain, are covered by the insulation covers 40, and then the bus bars B1 and B2 are laser welded to the third junction surfaces S3 of the positive electrode terminal 20 and the negative electrode terminal 21, respectively.

As described above, with the insulation covers 40 thus provided, the insulation properties of the electrode terminals can be improved, thereby enhancing the safety thereof as well.

### Fourth Embodiment

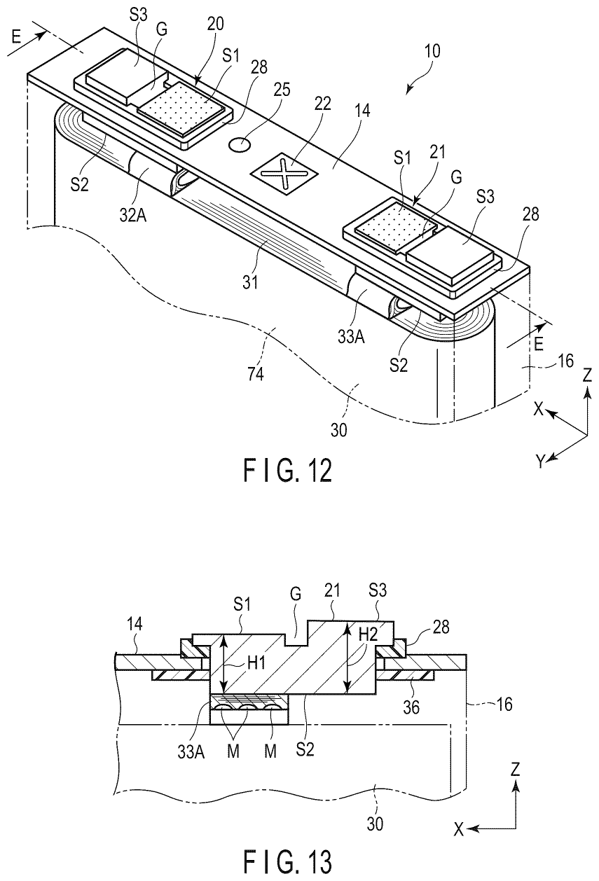

FIG. 12 is a perspective view showing a secondary battery of the fourth embodiment, with omission of the container body, and FIG. 13 is a cross-sectional view of the lid and electrode terminals, taken along line E-E in FIG. 12.

As shown in the figures, according to the secondary battery 10 of the fourth embodiment, the positive electrode terminal 20 and the negative electrode terminal 21 include a first junction surface S1 and a third junction surface S3, respectively, as in the case of the second embodiment provided above. According to the fourth embodiment, the first junction surface S1 is formed at a height lower than that of the third junction surface S3. The distance (height H1) between the first junction surface S1 and the second junction surface S2 is shorter than the distance (height H2) between the third junction surface S3 and the second junction surface S2. In other words, the thickness H1 of the portion of the first junction surface S1 is less than the thickness H2 of the portion of the third junction surface S3 (H1≤H2) in the positive terminal 20 and the negative terminal 21.

As described above, by making the thickness H1 of the portion of the first junction surface S1 of the electrode terminal, that is, the portion to be ultrasonically joined to the current collecting tab group, less, ultrasonic junction can be easily performed. Basically, as the plate material to be joined is thinner, the ultrasonic junction becomes easier.

In the second, third, and fourth embodiments provided above, the other configurations of the secondary battery 10 are identical to those of the secondary battery of the first embodiment. Therefore, in any of the second, third, and fourth embodiments, advantageous effects similar to those of the aforementioned first embodiment, namely, an increase in volumetric energy density and a reduction in manufacturing cost, can be achieved in the secondary battery.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

For example, the electrode body is not limited to a so-called wound type electrode body in which an electrode plate is wound, but a so-called stacked type electrode body in which a plurality of electrode plates are stacked in the thickness direction may as well be applied. Further, the number of electrode bodies to be housed in the outer container is not limited to one, but there may as well be a plurality of electrode bodies.

The materials, shapes, sizes, and the like of the elements constituting the secondary battery are not limited to those in the above-described embodiments, and can be modified in various ways as necessary.

What is claimed is:

1. A secondary battery comprising:
an outer container;
an electrode terminal attached to the outer container and including a first junction surface exposed to an outside of the outer container and a second junction surface exposed to an inside of the outer container and opposing the first junction surface; and
an electrode body housed in the outer container, including an electrode group and a current collecting tab group containing a plurality of current collecting tabs extending from the electrode group and directly joined to the second junction surface of the electrode terminal.

2. The secondary battery of claim 1, wherein
the first junction surface includes a plurality of pressure marks, and
the current collecting tab group includes a plurality of pressure marks.

3. The secondary battery of claim 2, wherein
the electrode terminal includes a third junction surface exposed an outside of the outer container and located alongside the first junction surface, and
the second junction surface includes a region opposing the first junction surface, to which the current collecting tab group is joined.

4. The secondary battery of claim 3, further comprising an insulating cover attached to the electrode terminal and covering the first junction surface.

5. The secondary battery of claim 3, wherein
a thickness of the electrode terminal between the first junction surface and the second junction surface is less than a thickness thereof between the third junction surface and the second junction surface.

6. The secondary battery of claim 1, wherein
the electrode terminal includes a third junction surface exposed an outside of the outer container and located alongside the first junction surface, and
the second junction surface includes a region opposing the first junction surface, to which the current collecting tab group is joined.

7. The secondary battery of claim 1, wherein
the outer container includes a rectangular container body having a top opening and a rectangular plate-shaped lid fixed to the container body so as to close the top opening,
the electrode terminal is attached to the lid body, and the first junction surface and the second junction surface extend approximately parallel to the lid body,
the electrode group of the electrode body includes one end surface opposing an inner surface of the lid body with a gap therebetween, and
the current collecting tab group extends from the one end surface and is joined to the second junction surface.

8. A method of manufacturing a secondary battery comprising an outer container, an electrode terminal including a first junction surface and a second junction surface opposing the first junction surface and attached to the outer container, and an electrode body contained within the outer container, the method comprising:
disposing a current collecting tab group of the electrode body so as to be in contact with the second junction surface of the electrode terminal;
pressing an anvil of an ultrasonic junction device against the first junction surface so as to interpose the electrode terminal and the current collecting tab group from both sides, and while pressing a horn of the ultrasonic junction device against the current collecting tab group, subjecting the anvil and the horn to ultrasonic vibration so as to apply ultrasonic waves to the electrode terminal and the current collecting tab group, thereby ultrasonically joining and the current collecting tab group to the second junction surface of the electrode terminal.
